(19) United States
(12) Patent Application Publication
(10) Pub. No.: US 2013/0253725 A1
(43) Pub. Date: Sep. 26, 2013

(54) SYSTEM AND METHOD FOR APPLIANCE ACTIVATION AND DEACTIVATION IN ACCORDANCE WITH RELIGIOUS OBSERVANCE

(71) Applicant: Eitiel EZRA, Bnei Brak (IL)

(72) Inventor: Eitiel EZRA, Bnei Brak (IL)

(21) Appl. No.: 13/848,152

(22) Filed: Mar. 21, 2013

(30) Foreign Application Priority Data
Mar. 22, 2012 (IL) 218806

(51) Int. Cl. G05B 13/02

(52) U.S. Cl. CPC G05B 13/02
USPC 700/296

(57) ABSTRACT

The invention consists of an electrical circuit having an internal CPU with clock, and means for switching external loads. By means of the CPU, clock, and possibly internal lookup tables, times during which certain circuits are to be switched off or on are determined. For example the CPU may be programmed to determine the time of the Sabbath onset each week, this time in fact shifting with the seasons as it is linked to the time of sunset. By use of the switching means (which may be implemented in the form of relays for instance) appliances such as lights, heaters and the like may be switched on or off for the duration of various events such as Sabbath, holidays, and the like, in accordance with yearly or multi-year calendars.

### BACKGROUND

1. Technical Field

Embodiments of the present invention relate generally to systems and methods for automatic activation and/or deactivation of electrical devices in adherence with religious proscriptions and observances.

2. Description of Related Art

Religions often develop accretions of ritual, which can involve temporally-based restrictions or imperatives. For instance the Jewish Sabbath begins Friday at some duration before sundown, continuing until Saturday some brief period sundown, with the exact starting and stopping points being precisely calculated to the minute according to certain Talmudic or Biblical prescriptions, astronomical or phenomenological factors peculiar to the location, and variations particular to subculture (such as Askenazi vs. Sephardi). Sunrise, sunset, the amount of time therebetween, the number of visible stars, the ability to distinguish between certain shades of color, the moment when one can recognize a familiar acquaintance, the advent of equinoxes and solstices, and the sun's angular position upon rising are all factors that determine times and intervals specified for various observances such as fasts, feasts, and everything between.

During Sabbath and other holidays, various actions are required while others are forbidden for the observant Jew. On the Sabbath for instance, there are proscribed actions deriving from 39 categories of work; amongst these proscribed actions is the activation and deactivation of electronic circuits, including turning lights on (for instance by opening a refrigerator door that turns on an interior refrigerator light), operating an air conditioner, running a water heater, etc.

To simplify the use of electric appliances in a religious household, daily or weekly timers have come into use that connect or disconnect a plug from line voltage, depending upon time of day (and in some cases day of week). Thus for instance an air-conditioner may be plugged into such a timer set to turn on at 15:00 every Saturday, to cool a hot household without the inhabitants having to desecrate the Sabbath by doing so manually.

However these devices are generally adapted to pass line voltage only, and have no provision for yearly events or location awareness. Hence, an improved method for religious timing issues is still a long felt need.

### BRIEF SUMMARY

It is within provision of the invention to implement a system for activation and/or deactivation of electrical circuits in accordance with a calendar consisting of:
a. computing means comprising a CPU, clock, and calendar;
b. switching means adapted for activation and deactivation of external circuits by means of connecting and disconnecting said circuits from a power source;
   wherein appliances can be automatically activated and deactivated in accordance with yearly and multi-year calendrical considerations.

It is further within provision of the invention wherein said calendar is determined by means selected from the group consisting of: direct calculation; table lookup; and combinations thereof.

It is further within provision of the invention wherein said switching means comprises two pluralities of relays operated in tandem such that when a first plurality of relays is opened, the second is closed, and vice versa.

It is further within provision of the invention wherein said relays are adapted to pass a current of 16 amperes and voltage of 250V AC.

It is further within provision of the invention wherein said computing means comprises a battery backup allowing it to run without external power for some duration.

It is further within provision of the invention further provided with screw terminals adapted for use in a mains electrical box.

It is further within provision of the invention adapted to control an interior refrigerator light.

It is further within provision of the invention adapted to control a circuit in parallel with external control, such that said switching means may activate or deactivate said circuit in parallel with said external control.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates an embodiment of the device implementing a one-pole one-throw switch;

FIG. 2 illustrates an embodiment of the device implementing a two-pole single-throw switch, one normally-off and one normally-on;

FIG. 3 illustrates an embodiment of the device implementing multiple independently controlled relays.

FIG. 4 illustrates an embodiment of the device suitable for use in electrical supply cabinets.

FIG. 5 illustrates the inventive device in parallel with a manual switch.

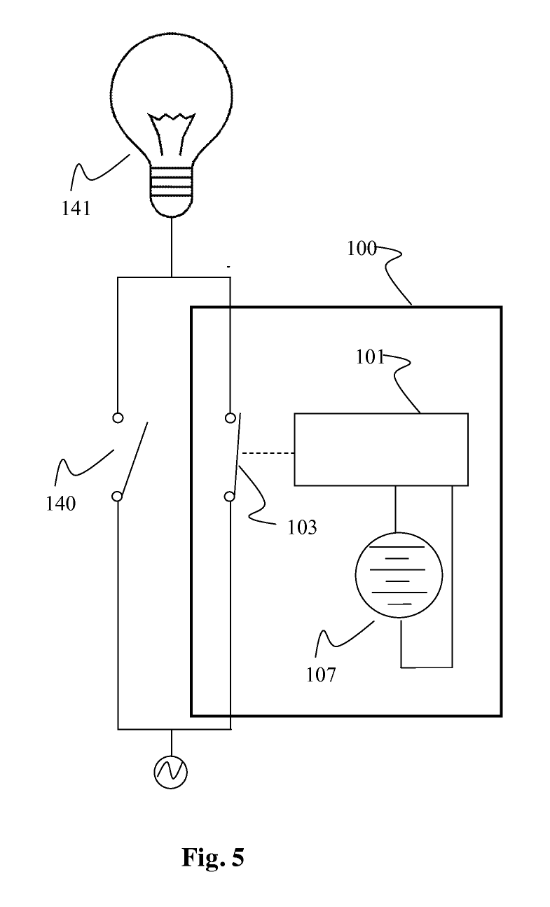

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for appliance activation and deactivation in accordance with religious observance.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1, 5, or 10).

The invention consists of an electrical circuit having an internal CPU with memory, clock, and means for switching external loads. By means of the CPU and clock, times during which certain circuits are to be switched off or on are determined. For example the CPU may be programmed to determine the start and end time of the Sabbath each week and the start and end time of religious holidays, this start and end time in fact shifting with the seasons as it is linked to the time of sunset.

Given a CPU that has determined that the Sabbath has commenced or is about to commence, a set of switches may now be activated or deactivated to allow for external devices to be activated or deactivated.

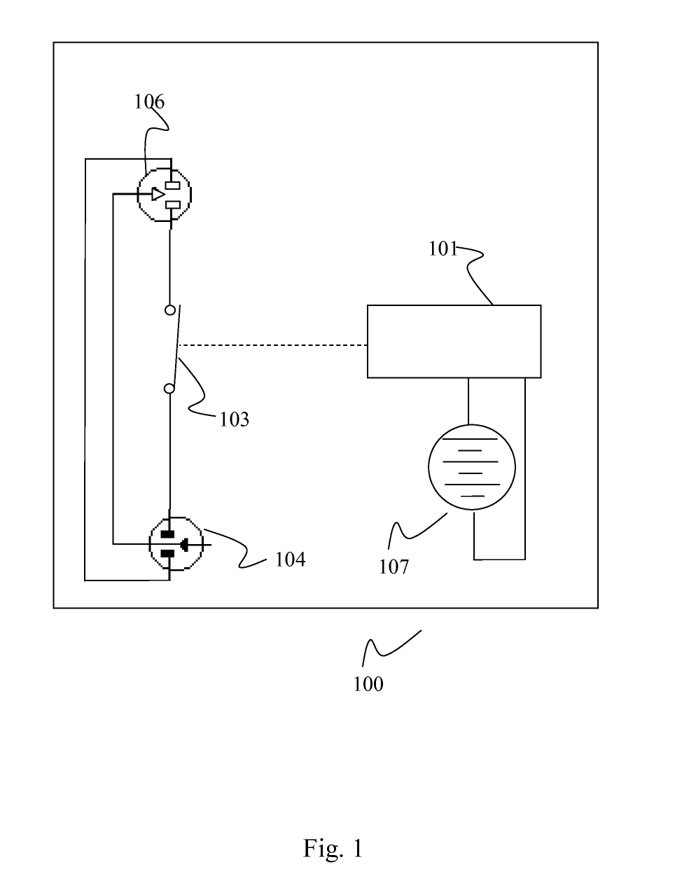

The simplest example contemplated is shown in FIG. 1. Here a CPU 101 operating from a battery 107 controls a single-pole, single-throw, normally-closed switch 103. This switch has the role of connecting or disconnected the hot lead of a plug 104 to that of a socket 106. The other leads in this example are left connected. Thus an appliance plugged into socket 106 will be fully electrically connected to plug 105 only when switch 103 is closed (as shown). If switch 103 is open, then only ground and neutral leads are connected, and the device will not be supplied any power. The closure of switch 103 is controlled by CPU 101. An example of such an electrically controllable switch might be a transistor switch, which is suitable for switching low DC loads, or a relay (either an electromechanical sort or a solid-state relay). Use of relays has the advantage that relatively high voltage AC loads (such as appliances intended to plug into standard wall sockets) may also be switched, in addition to DC loads.

For example the DE1A-L-5V-ND general purpose relay is a single pole single throw (spst) relay as in 103 of FIG. 1, that is capable of switching up to 10 Ampere loads at maximum voltages of 250V AC. It is controlled by 5V control signal that draws 20 mA (this being the current the CPU would have to supply to activate or deactivate the relay, the current being drawn or not depending upon whether the relay is normally-open or normally-closed). Other relays can be easily found capable of switching higher currents, for example the ADJ11005-ND is capable of switching 16 Amperes at maximum 250V AC and has a cost of a few dollars. 16 Amperes is generally the maximum amount a single home circuit can draw without tripping the line fuse (in Israel for example a lighting circuit will carry 10 Amps maximum while a power circuit will carry 16 Amps maximum). Thus use of relays able to carry 16 Amperes and 250V AC will ensure that any and all household loads can be safely switched.

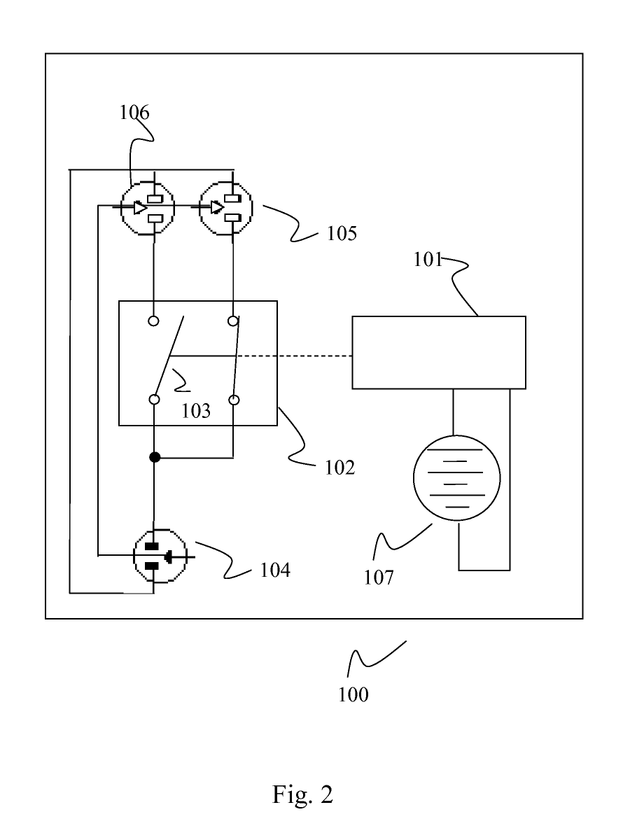

A second example is shown in FIG. 2. Here a double-pole single-throw (DPST) relay is employed, one normally-off and one normally-on. Devices plugged into the normally-on plug 105 will stay on during the week but are switched off just before Sabbath and holidays (or according to whatever schedule may be programmed into the CPU), while devices plugged into the normally-off switch will be switched on just before Sabbath and holidays. For most practical purposes the device of FIG. 2 will suffice, since any appliances to be turned off can be connected to a multi-member outlet connected to outlet 106 and likewise for any appliances to be turned on, a multi-member outlet can be connected to outlet 105 to supply them.

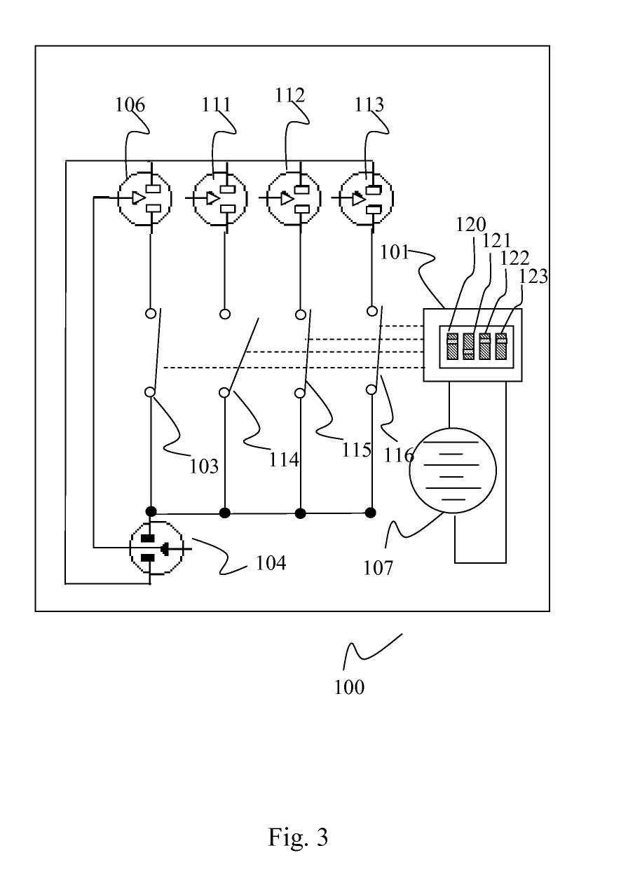

An example of a third embodiment is shown in FIG. 3. Here a number of separate sockets 106, 111, 112, 113 are switched by independently controlled relays 103, 114, 115, 116 respectively. The CPU 101 can thus control each socket independently from all other sockets; the DIP-switches 120-123 can be used (for instance) to set whether a given switch is normally-off or normally-on. Thus for instance dip-switch 121 is in the lower position corresponding to a normally-off operation of switch 114, while the rest are in the upper position corresponding to normally-on behavior of switches 103, 115, 116. This would allow certain capabilities not found in the device of FIG. 2, for example allowing for certain devices to be turned on or off only (for instance) during high holidays, while others may be turned off/on only during the Sabbath.

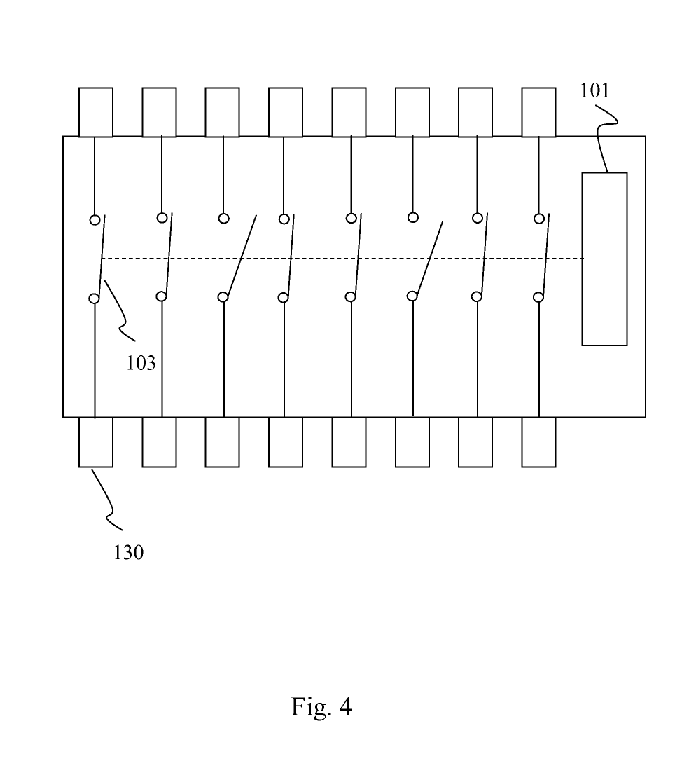

FIG. 4 presents an embodiment of the device suitable for use in an electric distribution box such as will be found in many homes and apartments. The screw terminals 130 permit connection of single hot leads for a number of house or apartment circuits to the switches 103 of the device, which in this example are all ganged to a single-pole multiple-throw switch connected to the microprocessor 101. In this way multiple circuits may all be controlled, each for instance having a normally-on or normally-off state controlled by a DIP switch as in FIG. 3.

In certain cases it is desirable to allow manual and computerized control of a circuit, for instance in the case of stairway lights. During the week one desires to allow the stairway lights to be turned on/off manually, but during the Sabbath for the lights to remain on. For such cases these lights may be simply connected in parallel to the regular switch and to the output of the device such as socket 106. This way users can manually switch the lights on if they are off, while the computer can still switch the lights on during appropriate times.

Such an arrangement is shown in FIG. 4. The inventive device is wire as usual (the plug and socket have been omitted for clarity). In parallel with the switched line another manually switched line is used to allow a manual switch 140 to turn on the appliance 141. Thus either the inventive device 100 or the manual switch 140 may be used to turn on the device; the circuit implements an ‘OR’ function. Obviously if the circuits were placed in series instead of parallel, they would implement an ‘AND’ function whereby only when both switches 140 and 103 are closed, will the appliance be powered. This may find use for situations for example when one wants to prevent use of an appliance in certain times, but allow its manual operation at other times.

It is within provision of the invention that a microcontroller be employed having CPU as mentioned, memory, program and the like, along with optional elements such as the display screen, user input means such as buttons or switches, and the like.

Examples of microcontrollers suitable for implementing the device are the ARM core processors, Atmel AVR, AVR32, AT91SAM Cypress Semiconductor PSoC, Freescale ColdFire and S08, Freescale 68HC11 , Intel 8051, Infineon: 8, 16, 32 Bit microcontrollers, MIPS, Microchip Technology PIC, NXP Semiconductors LPC series, Parallax Propeller, PowerPC ISE, Rabbit 2000, Renesas RX, V850, Hitachi H8, Hitachi SuperH, M16C, RL78, R8C, 78K0/78K0R, Silicon Laboratories Pipelined 8-bit 8051 Microcontrollers and mixed-signal ARM-based 32-bit microcontrollers, STMicroelectronics STM8, ST10 and STM32, Texas Instruments TI MSP430, Toshiba TLCS-870 (8-bit/16-bit).

The Arduino for instance is based on the Atmel AVR microcontroller, with USB capability to allow for easy programming via a standard PC with USB port. These microcontrollers have a minimal cost of some tens of dollars, have multiple lines of digital signal outputs that are suitable for running the relays discussed above, as well as internal memory capable of storing calendar information including Sabbath and holiday timing over one or more years. Alternatively the memory may store a program designed to compute the times of these occurrences. A hybrid approach may also be used where the seasonal variations in timing are computed while the multi-year variations (such as the extra days removed or added to certain months in certain years, or the occurrence of extra months) be stored.

Given the low power consumption of such microcontrollers (which in many cases have ‘sleep’ modes that can be used to minimize power consumption until certain timing events occur) the entire device can in principle be made battery driven. It is within provision of the invention that the device in fact be battery operated with the ability to draw power either from the lines being switched or from an external source such as AC or DC power supply.

It is further within provision of the invention that it be used as a portable calendar. The determination of the times defined for various restrictions and/or requirements has historically been computed either by hand or tabulated using computing devices, and entered into lists published in various forums such as places of observance or the internet. However an observant religious person desiring to adhere to these strictures and (for instance) finding him/herself without access to such material (or in doubt whether such access is allowable, as internet use (for instance) is prohibited at certain times which themselves might be listed on the internet) may be at a loss concerning the proper course of action.

Thus it is within provision of the invention that the device described above be useful as a portable clock indicating advent, termination, and duration of various religious events.

For instance, the device may be formulated in a compact format the size of a credit card. This card may be carried in the wallet, and has provision to indicate that the Sabbath will arrive in the next 15 minutes (for instance by means of a certain LED being activated), that the Sabbath has arrived (for instance by means of another LED being activated), and that the Sabbath is over (for instance by means of all LEDs being deactivated).

It is further within provision of the invention that location awareness be provided by means of (for example) a GPS receiver. By means of this receiver the current device location can be inferred, and from the this the times for various religious occurences calculated without any user intervention whatsoever.

In the case the device is not location-aware, the current local time would have to be input by the user once.

It is within provision of the device that battery backup be used to keep the clock running, often referred to a the RTC battery. For example a standard CR2032 lithium battery may be employed for this purpose, such that even if external power is removed and the internal battery removed, the clock remains operating.

It is within provision of the invention that multiple-year calendars be implemented in the computing means of the device. For example the Jewish calendar is a hybrid solar-lunar calendar, the months following a lunar cycle and a thirteenth month of Adar I being added occasionally to synchronize with the solar calendar. The entirety comprises a 19 year cycle, with Adar I being added in the 3rd, 6th, 8th, 11th, 14th, 17th and 19th years of the cycle. Other complexities are also within provision of the invention; in the Jewish calendar, Yom Kippur should not fall adjacent to the Sabbath, because this would cause difficulties in coordinating the fast with Sabbath, and Hoshanah Rabbah should not fall on Saturday because it would interfere with the holiday's observances. Thus a day is added to certain months or subtracted from others prevent these conflicts from occurring. Alternatively the tabular Islamic calendar, in which months are worked out by arithmetic rules rather than by observation or astronomical calculation, has a 30-year cycle with 11 leap years of 355 days and 19 years of 354 days. Therefore it is within provision of the invention that a multi-year calendar be maintained (for example a 19-year calendar) in the computing means of the device, with provision for calculation of the various holidays in accordance with a given religion's particular calendar calculations. This multi-year calendar may be implemented by means of direct computation, or by means of table lookup.

It is within provision of the invention that the calendar of the device be reprogrammable, for instance by means of interfacing with an external PC.

It is within provision of the invention that repeated relatively high speed switching be implementable using the device; thus for instance it may be possible to run a water boiler at effective half power by means of periodically switching the heating source on and off with a period of seconds or minutes.

It is within provision of the device to operate wireless switches. Thus for instance a set of plugs and sockets having relays that can be opened or closed using wireless signals may be employed, allowing a single microcontroller to operator a number of remote appliances. It is within provision of the invention that these wireless devices be independently addressable for instance by means of unique IDs for each device.

As will be appreciated in ordinary timers, be they daily weekly or otherwise, one must manually enter desired outlet activation and deactivation times. Furthermore for events linked to physical phenomena such as sundown, the time is shifting with change of seasons requiring manual recalibration every week or so.

It is within provision of the invention that mechanical elements be incorporated in the device that may be activated only at certain times. For instance a mechanical flow meter may be activated by the device such that flow is measured on the Sabbath mechanically, while a digital flow meter is deactivated during these times. It is within provision of the invention that power for the mechanical elements be derived for instance from the flow being measured, or other mechanical parameter being dealt with.

It is within the provision of the invention to have a default state that will be applied in case of system or electrical fault. In said default state the device will automatically operate on “Shabbat mode” in order to avoid any Shabbat and holiday desecration.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A system for activation and deactivation of electrical circuits in accordance with a calendar consisting of:
a. computing means comprising a CPU and memory;
b. switching means adapted for activation and deactivation of external circuits by means of connecting and disconnecting said circuits from a power source;
wherein appliances can be automatically activated and deactivated in accordance with yearly and multi-year calendrical considerations.

2. The system of claim 1 wherein said calendar is determined by means selected from the group consisting of: direct calculation; table lookup; and combinations thereof.

3. The system of claim 1 wherein said switching means comprises two pluralities of relays operated in tandem such that when a first plurality of relays is opened, the second is closed, and vice versa.

4. The system of claim 3 wherein said relays are adapted to pass a current of 16 amperes and voltage of 250V AC.

5. The system of claim 1 wherein said computing means comprises a battery backup allowing it to run without external power for some duration.

6. The system of claim 1 further provided with screw terminals adapted for use in a mains electrical box.

7. The system of claim 1 adapted to control an interior refrigerator light.

8. The system of claim 1 adapted to control a circuit in parallel with external control, such that said switching means may activate or deactivate said circuit in parallel with said external control.

9. The system of claim 1 having a default mode in which Shabbat rules are applied.

10. A method for activation and deactivation of electrical circuits in accordance with a calendar consisting of:
a. providing computing means comprising a CPU and memory;
b. providing switching means adapted for activation and deactivation of external circuits by means of connecting and disconnecting said circuits from a power source;
c. activating and deactivating external circuits by use of said switching means automatically in accordance with said calendar;
wherein appliances can be automatically activated and deactivated in accordance with yearly and multi-year calendrical considerations.

11. The method of claim 10 wherein said calendar is determined by means selected from the group consisting of: direct calculation; table lookup; and combinations thereof.

12. The method of claim 10 wherein said switching means comprises two pluralities of relays operated in tandem such that when a first plurality of relays is opened, the second is closed, and vice versa.

13. The method of claim 12 wherein said relays are adapted to pass a current of 16 amperes and voltage of 250V AC.

14. The method of claim 10 wherein said computing means comprises a battery backup allowing it to run without external power for some duration.

15. The method of claim 10 further provided with screw terminals adapted for use in a mains electrical box.

16. The method of claim 10 adapted to control an interior refrigerator light.

17. The method of claim 10 adapted to control a circuit in parallel with external control, such that said switching means may activate or deactivate said circuit in parallel with said external control.

18. The method of claim 10 having a default mode in which Shabbat rules are applied.
